(19) United States
(12) Patent Application Publication
(10) Pub. No.: US 2015/0208127 A1
(43) Pub. Date: Jul. 23, 2015

(54) MATCHING TELEVISION AND MOVIE DATA FROM MULTIPLE SOURCES AND ASSIGNING GLOBAL IDENTIFICATION

(71) Applicant: Google Inc., Mountain View, CA (US)

(72) Inventors: Randy Simon, Oakland, CA (US); Erez Louidor, Mountain View, CA (US); Brian Gogan, Aptos, CA (US)

(73) Assignee: Google Inc., Mountain View, CA (US)

(21) Appl. No.: 13/843,372

(22) Filed: Mar. 15, 2013

(51) Int. Cl. H04N 21/462; H04N 21/2665

(52) U.S. Cl. CPC H04N 21/4622; H04N 21/2665

(57) ABSTRACT

Disclosed is a method including receiving programming data from programming data stores, each of the received programming data having a data store identification, converting each of the programming data to a common data format, the common data format being different than a data formats of the received data, maintaining a list of unique identifications of converted programming data, associating converted like programming data received from the programming data stores with one of the unique identifications, wherein like programming data received from different programming data stores is associated with the same program content, selecting one of the programming data stores associated with the like programming data as a programming data source for each of the associated unique identifications, and generating a unified view of the converted programming data including each of the associated unique identifications and each of the selected data sources.

### BACKGROUND

Embodiments relate to converting and matching television and movie data and making the data available for discovery by a client.

In Internet based television (TV) and movie programing discovery applications, the application provides data to clients that aggregates TV and Movie availability and related metadata across multiple provider sources. Most providers define their own identification space to identify entities like Movies, Series, Episodes, Celebrities, Sports Teams and others. Typically, the application provides duplicate entities from the various providers and allow for look up of those duplicate entities by over multiple entities. This duplication results in data overload for a client device or user as regards availability of programming and results excessive data to search and/or look-up using the discovery applications.

### SUMMARY

Example embodiments convert data from many television programming providers and/or many providers of information about television programming into a common format or representation. The converted data may be organized such that a unique program is presented to a TV viewer (e.g., in a searchable guide) once. The TV viewer may search the organized, converted data and select programming to view (or record, etc.).

One embodiment includes a method. The method includes receiving programming data from a plurality of programming data stores, the programming data being in one of a plurality of formats, each of the received programming data having a data store identification, converting each of the programming data to a common data format, the common data format being different than each of the plurality of data formats of the received data, maintaining a list of unique identifications of converted programming data, associating converted like programming data received from the plurality of programming data stores with one of the unique identifications, wherein like programming data received from different programming data stores is associated with the same program content, selecting one of the plurality of programming data stores associated with the like programming data as a programming data source for each of the associated unique identifications, and generating a unified view of the converted programming data including each of the associated unique identifications and each of the selected data sources.

Another embodiment includes an apparatus. The apparatus includes at least one processor, and at least one memory. The at least one memory storing code segments that when executed by the processor cause the processor to receive programming data from a plurality of programming data stores, the programming data being in one of a plurality of formats, each of the received programming data having a data store identification, convert each of the programming data to a common data format, the common data format being different than each of the plurality of data formats of the received data, maintain a list of unique identifications of converted programming data, associate converted like programming data received from the plurality of programming data stores with one of the unique identifications, wherein like programming data received from different programming data stores is associated with the same program content, select one of the plurality of programming data stores associated with the like programming data as a programming data source for each of the associated unique identifications, and generate a unified view of the converted programming data including each of the associated unique identifications and each of the selected data sources.

### BRIEF DESCRIPTION OF THE DRAWINGS

FIG. 1 is a flow chart of a process of handling programming data.

FIG. 2 is a schematic block diagram of a system for receiving and viewing content.

FIG. 3 is a schematic block diagram of a system for converting, matching and unifying data from multiple systems.

FIG. 4 is a flowchart of a method for converting, matching and unifying data from multiple systems.

FIG. 5 is a flowchart of a method for merging data from multiple systems.

FIG. 6 is a schematic block diagram an example computer device.

FIG. 7 is a schematic block diagram of another example computer device.

These Figures illustrate the general characteristics of methods, structure and/or materials utilized in certain example embodiments and supplement the written description provided below. The use of similar or identical reference numbers in the various drawings is intended to indicate the presence of a similar or identical element or feature.

### DETAILED DESCRIPTION

Example embodiments provide a common representation of television (TV) programming and TV related data (e.g., program, show, person, sports, schedule, and the like) to a TV viewer or client. The TV programming and TV related data may be used by a TV viewer for selecting a program to watch on his or her TV. The programming data may indicate when a program is available. For example, a particular college football game may be available on a Saturday at a predetermined time (e.g., 1:00 pm). The TV related data may include the college football teams playing, the location of the game, team records, team conferences, and the like. The TV viewer may use the TV programming and TV related data to search for a program in many ways. For example, the TV viewer may search for a team, a time a game may be available, and the like. Another TV programming example may be a movie. The programming data may indicate when and on what channel the movie is available. The TV related data for the movie may include the name of the movie, the actors, the director, the rating, and the like. The TV viewer may use the TV programming and TV related data to search for the movie in many ways. For example, the TV viewer may search for the movie directly, search for an actor, etc.

The TV programming and TV related data may be available in any number of formats based on the provider of the data. The TV viewer may have difficulty searching for programming, because the TV programming and TV related data may be in different formats. For example, the TV viewer may need to search all the clients separately and/or the search tool may be excessively complex in order to search across providers. Therefore, example embodiments convert this data to the common representation. For example, the common representation may be a particular data structure. Data can be received from a source and converted into a common (e.g., a common data structure) representation. The data can be converted from a plurality of data sources (e.g., TMS, Netflix, Amazon, Dish video-on-demand (“VOD)”, and the like) including international sources. In general, the converted data can be consumed by a plurality of clients.

Example embodiments may take data that is in various representations and convert the data to a single common representation. This allows a plurality of clients to be agnostic to the source of the data. An advantage of using the common representation (e.g., common data structure) over consuming the data directly from the provider is, for example, generating conversion code once for all providers. Another advantage may be that if an alternate provider is used (or added), the new provider may have little to no effect on data usage because the data has been converted to a common representation. The common representation may be somewhat de-normalized and may provide a simpler and cleaner view as compared to the raw provider data. The common representation of the data may be combined from the plurality of sources into a single output. Example embodiments may provide data matching such that data items from one provider may be matched to data items from another provider.

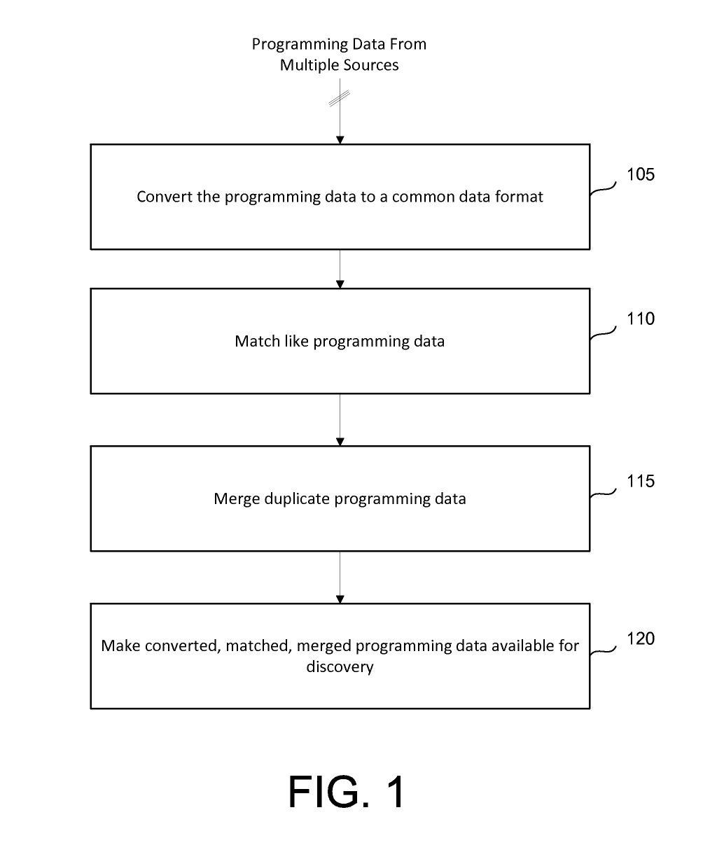

FIG. 1 is a block diagram showing a flow of programming data according to at least one example embodiment. As shown in FIG. 1, programming data may be received from multiple data sources and converted into a common data format (block 105). For example, the plurality of data sources (e.g., Tribune Media Services (“TMS”), Netflix, Amazon, Dish video-on-demand (“VOD)”, and the like) may have associated programming data formatted in any one of a plurality of formats (e.g., XML, CSV, and the like). The programming data may be converted into a common format that stores information about the programming data. The information may include, for example, a program name, a program source, schedule information, actors' names, team names, and the like. Elements used in the data structure for unique programming data may have associated identification numbers.

The converted programming data may include similar or duplicate data. For example, two providers may provide the same program (e.g., a movie or a sporting event) available for viewing. Therefore, the similar programming data from the different providers, which refers to the same program may be matched (block 110). For example, the data structure defining the common data may include an identification for a plurality of similar programming data from different data sources. Therefore, the data structure may store the identification number in relation to the data source (e.g., as a provider identification and provider assigned identification pair for the programming data) for each of the data sources including the like programming data.

The programming data may be collected over time. Therefore, existing converted programming data for a particular program may match a new instance of the programming data (e.g., programming data received from a new data source or newly added or duplicated in an existing data source). The new instance (or plurality of instances) may be merged or unified with the existing converted programming data (block 115). The converted, matched, and merged programming data may be made available for discovery by a client (block 120) using, for example, an application programming interface (API). The programming data made available for discovery by the client is unique in that a program (e.g., a movie or sporting event) is only discoverable once by the client regardless of the number of data sources that make the program available.

Although the above discussion refers to programming data (e.g., data having an associated schedule and/or viewable content), example embodiments are not limited thereto. For example, non-programming data (e.g., data without scheduled and/or associated viewable content) may be converted, matched and made discoverable. For example, data graph triples (discussed in more detail below) may be converted, matched and made discoverable.

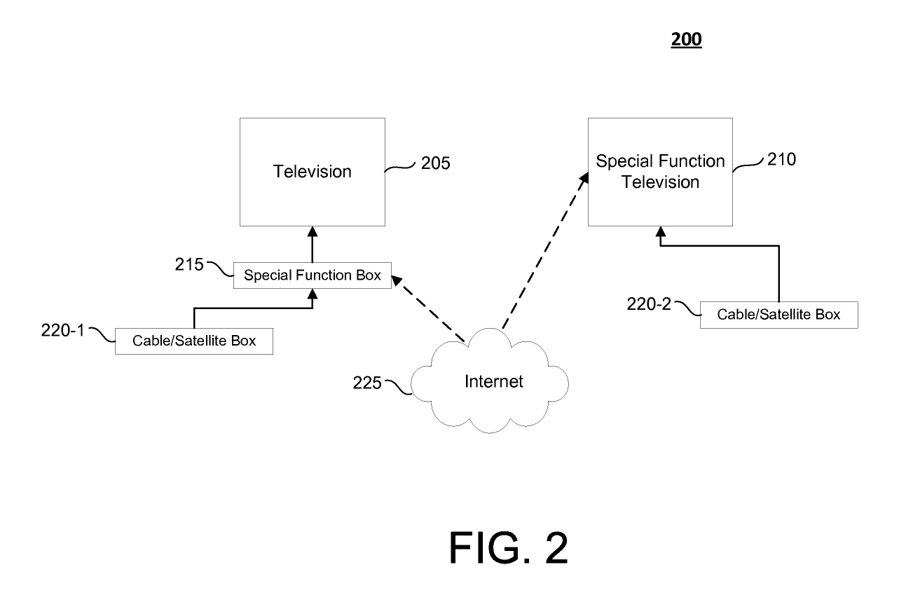

FIG. 2 is a schematic block diagram of a system for receiving and viewing content. As shown in FIG. 2, the system 200 includes a television 205, a special function television 210, a special function box 215, cable/satellite boxes 220-1 and 220-2, and internet 225. The television 205, special function box 215, and cable/satellite box 220-1 may be interconnected via a standard interface cable (e.g., High-Definition Multimedia Interface (HDMI) cable). The special function television 210, and cable/satellite box 220-2 may be interconnected via a standard interface cable (e.g., HDMI cable). The special function box 215 and the special function television 210 may be, indirectly, connected to the internet 225 via a standard interface (e.g., IEEE 802.11 (WIFI), or Internet Protocol (IP)).

The television 205 may be configured to receive and display video programing as well as other video applications (e.g., games, applications, web browsing, and/or the like). The video programming may be received over the air and/or via the special function box 215 or the cable satellite box 220-1.

The special function box 215 may be configured to perform any number of special functions. For example, the special function box 215 may be configured to provide an interface to the internet 225 for web browsing or email. For example, special function box 215 may be configured to receive special programming or to perform/process applications (e.g., games) via the internet 225. Cable/satellite boxes 220-1 and 220-2 may be configured to receive communicate with a satellite or cable provider and convert the signals associated with the communication to video programming and/or video data for display on the television 205 and/or the special function television 210.

The special function television 210 may be configured to receive and display video programing as well as other video applications (e.g., games, applications, web browsing, and/or the like). The video programming may be received over the air and/or via the cable satellite box 220-1. The special function television 210 may also be configured to perform the functions of the special function box 215 without a separate box. For example, the special function television 210 may be configured to receive special programming or to perform/process applications (e.g., games) via the internet 225.

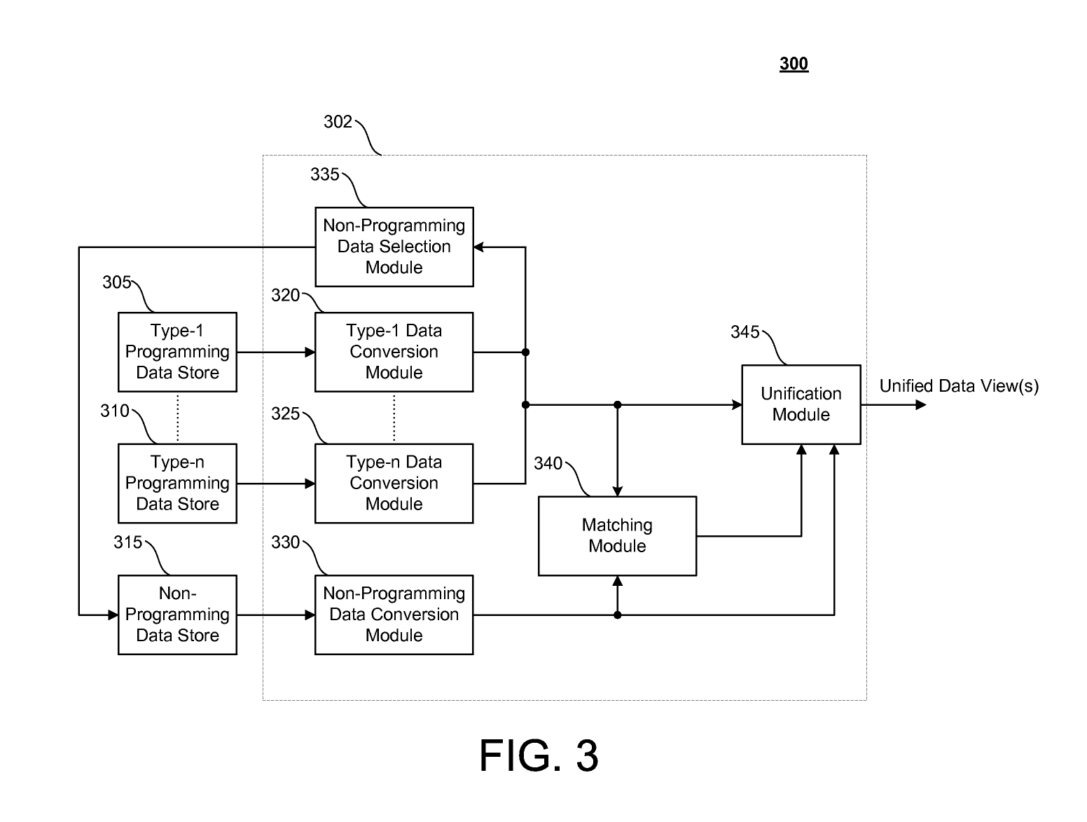

FIG. 3 is a system 300 for converting, matching and unifying (e.g., merging) data from multiple systems according to example embodiments. The blocks/modules described with regard to FIG. 3 may be executed as software code stored in a memory associated with the system 300 and executed by at least one processor associated with the system 300. In some embodiments the system 300 may include an application-specific integrated circuit, or ASIC that executes the blocks/modules described with regard to FIG. 3.

As shown in FIG. 3, system 300 includes a plurality of programming data stores 305, 310, a non-programming data store 315, and the data matching and unification module 302. The data matching and unification module 302 includes a plurality of data conversion modules 320, 325, a non-programming data conversion module 330, a non-programming data selection module 335, a matching module 340, and a unification module 345.

In the below discussion programming data and non-programming data is referred to. Non-programming data may be any information about a viewable program or content (e.g., movie or sporting event). For example, non-programming data may include an actor's name, a director's name, a rating, a sport, a team name, a player, an event location, and the like. However, non-programming data may not include information about a program availability or scheduling (e.g., who the provider is, when the program is available for viewing, and the like). Programming data may include some or all of the non-programming data. In addition, programming data may include information about the program availability or scheduling (e.g., who the provider is, when the program is available for viewing, and the like).

The plurality of programming data stores 305, 310 may be configured to store programming data. The stored programming data may be available for consumption (e.g., viewing or storing for later viewing) by a client having access (e.g., a use subscription) to the programming data. Each of the plurality of programming data stores 305, 310 may have an associated data store identification. Each of the plurality of programming data stores 305, 310 may store data in a different format. For example, the plurality of data sources (e.g., TMS, Netflix, Amazon, Dish VOD, and the like) may have associated programming data formatted in any one of a plurality of formats (e.g., XML, CSV, and the like). The programming data may include associated information. The associated information may include, for example, program name, program source, schedule, actors, team names and the like. For example, the programming data may be associated with a sporting event. The associated information may include the type of sporting event (e.g., baseball), the teams that are playing, the date and time the game is to be played, a source name or provider identification (e.g., TMS), a source identification number or provider assigned identification (e.g., MLBRSY1234), and the like.

The non-programming data store 315 may be configured to store non-programming data. For example, non-programming data may be data about a movie (e.g., rating, actor and director), but not information about where or when the movie is available (e.g., no information regarding scheduling and/or viewable content). For example, non-programming data may be data about a sporting event (e.g., teams, location and sport), but not information about scheduling and/or viewable content for the sporting event. The non-programming data store 315 may have an associated data store identification. The non-programming data store 315 may store data in any format (e.g., data graph triples). A triple may represent two entities and the relationship between them, for example in a <subject; predicate; object> format. Triples are discussed in more detail below. The non-programming data may be used to supplement programming data (e.g., provide additional details about a sporting event or an actor in a movie), and the non-programming data may be formatted in any one of a plurality of formats (e.g., XML, CSV, data triples, and the like). The non-programming data may include associated information. The associated information may include, for example, program name, actors, team names and the like. For example, the programming data may be associated with a sporting event. The associated information may include the type of sporting event (e.g., baseball), the teams that are playing, rosters, win/loss records, and the like.

The plurality of data conversion modules 320, 325 may be configured to convert programming data received from a programming data store into a common format or representation. For example, the common format may be a data structure called “Item”. The data structure called “Item” may have a plurality of defined variables, constants and functions. The plurality of defined variables may be related to a program, a series, a station (e.g., TV station), an event (e.g., sporting event), online programming, and the like. Therefore, the data structure called “Item” may include variables labeled as Item.Program, Item.Series, Item.TvStation, Item.TvEvent, Item.Online, and the like. In the remaining disclosure, the term “Item” may be used interchangeably with the term “common format,” with the understanding that both refer to a representation of programming data. The term “Item” also infers the representation as a data structure.

As discussed above, the programming data may be received in any one of several different formats such as XML, CSV, and the like. The programming data may also be received in a proprietary format or may use a standard such as sitemaps or media rich site summary (mRSS). The plurality of data conversion modules 320, 325 may be configured to utilize a helper class stored in a common file stored in, for example, memory 604 (described below). The helper class may include provider or programming data store specific code including the lexicon for the provider or programming data store referenced (e.g., to parse the programming data) to the data structure variables. The plurality of data conversion modules 320, 325 may be configured to utilize the helper class in order to search the programming data for keyword variables related to the data structure variables and assign the corresponding values assigned to the keyword variables to corresponding data structure variables.

For example, the helper class for a provider or programming data store may include a reference to a keyword variable as TV.Show. The reference to the keyword variable TV. Show may map to the data structure element Item.Program in the helper class. The plurality of data conversion modules 320, 325 may be configured to utilize the helper class to determine the mapping and then search the programming data for TV.Show, read the variable assigned to TV.Show and assign the variable to Item.Program in the associated item.

Programming data may be received by the plurality of data conversion modules 320, 325 from the plurality of programming data stores 305, 310 continuously over time or periodically. For example, the plurality of data conversion modules 320, 325 and the plurality of programming data stores 305, 310 may be configured to communicate when the plurality of programming data stores 305, 310 has updated or changed programming data. For example, the plurality of data conversion modules 320, 325 and the plurality of programming data stores 305, 310 may be configured to communicate hourly, daily, weekly, upon start-up, before shutdown, etc.

Each data conversion module 320, 325 and programming data store 305, 310 pairing may be associated with a separate communication job (e.g., code that when executed creates the pairing and downloads data) such that each data conversion modules 320, 325 and programming data stores 305, 310 pairing may have different settings as to when and how the programming data may be communicated or downloaded. For example, the programming data may be communicated or downloaded using a tool that can make FTP requests on a schedule. As such, the programming data may be communicated or downloaded in a manner such that the programming data stores 305, 310 does not provide the data late (e.g., after live programming has ended), compensates if the download is slow (e.g., begins downloading earlier than configured) or increases download frequency if there are extra updates (e.g., live events with frequent scheduling changes like sporting league playoffs).

The non-programming data conversion module 330 may be configured to convert non-programming data from the non-programming data store 315 into a common format or representation. For example, the common format may be the above discussed data structure called “Item”.

As discussed above, the non-programming data may be received in any one of several different formats such as XML, CSV, and the like. According to example embodiments, the non-programming data may be received as triples associated with a data graph (described in more detail below). The non-programming data conversion module 330 may be configured to utilize a helper class stored in a common file stored in, for example, the memory 604 (described below). The helper class may include code specific to the non-programming data store 315, including a lexicon for the non-programming data store 315 that is referenced to the data structure variables (e.g., to parse the non-programming data). The non-programming data conversion module 330 may be configured to utilize the helper class in order to search the programming data for keyword variables related to the data structure variables and to assign the corresponding values assigned to the keyword variables to corresponding data structure variables.

For example, the helper class for the non-programming data store 315 may include a reference to a keyword variable as TV.Show (noting that TV.Show should not include information related to source or availability for the show). The reference to the keyword variable TV.Show may map to the data structure element Item.Program in the helper class. The non-programming data conversion module 330 may be configured to utilize the helper class to determine the mapping and then search the programming data for TV.Show, read the variable assigned to TV.Show and assign the variable to Item.Program in the associated item.

Like programming data, non-programming data also may be received by the non-programming data conversion module 330 from the non-programming data store 315 continuously over time or periodically. For example, the non-programming data conversion module 330 and the non-programming data store 315 may be configured to communicate when the non-programming data store 315 has updated or changed non-programming data, or the non-programming data conversion module 330 and the non-programming data store 315 may be configured to communicate hourly, daily, weekly, upon start-up, before shutdown, etc.

The non-programming data selection module 335 may be configured to select converted programming data and to convert the selected converted programming data into the data format associated with the non-programming data store 315. For example, the data format associated with the non-programming data store 315 may be associated with a data graph. Data associated with a data graph may be formatted as a triple which represents two entities and the relationship between them, for example in a <subject; predicate; object>format. In addition to triples obtained directly from the data graph, the system may also create additional triples to assist text searches of the data graph.

According to example embodiments, the non-programming data store 315 may be a graph-based data store configured to stores triples, also referred to as tuples that represent entities and relationships. A triple may include a <subject; predicate; object> format, with the subject representing a starting entity, the predicate representing an outward edge from the subject, and the object representing the entity pointed to by the outward edge. For example, one example of a triple may be the entity “Tom Hanks” as the subject, the relationship acted in as the predicate, and the entity “Larry Crowne” as the object. Of course, a data graph with a large number of entities and even a limited number of relationships may have billions of triples.

The non-programming data selection module 335 may be configured to receive programming data in the converted data format and convert the programming data to the triple format. The non-programming data selection module 335 may be configured to select programming data from one or more of the plurality of data conversion modules 320, 325. The non-programming data selection module 335 may be configured to select programming data that is relevant to the non-programming data store 315 (e.g., actors in a movie or rating of a movie). The formatted (e.g., triples) output is used as input to the non-programming data store 315. The non-programming data store 315 may include a module configured to ingest the formatted (e.g., triples) output data (not shown). The module configured to ingest the formatted (e.g., triples) output data may be configured to combine entities from various sources, to assign them a single identification, and to index the formatted (e.g., triples) output data.

The matching module 340 may be configured to produce matched items that associate programming data from one programming data store or provider with programming data from another programming data store or provider. This matched programming data may be referred to as “like programming data” if both programming data stores, or providers include the same (or substantially similar) programming data. In other words, like programming data is a same programming data stored in more than one of the programming data stores 305, 310. By contrast, “non-like programming data” may be items that do not have the same programming data stored in another programming data store 305, 310.

Further, the converted programming data and non-programming data may include like or duplicate data. As such, two providers may have the same programming data (e.g., movie or sporting event) available for viewing. Therefore, the programming data and non-programming data may be matched as a match item including like programming data. A match item may be an extension of an item in that a match item inherits all of the structure associated with an item and extends the structure of an item as described below. For example, a match item may be defined in terms of an item, and a match item may represent programming data in the common format.

For example, the data structure defining the common data may include an identification (e.g., match item) for a plurality of like programming data from different data sources. Therefore, the data structure may store the identification number in relation to the data source (e.g., as a provider identification and provider assigned identification pair for the programming data) for each of the data sources including the like programming data. For example, for a movie (e.g., “Blade Runner”) the matching module 340 may be configured to produce the match item including different identification numbers based on the source of the data.

The matching module 340 may be configured to produce match items utilizing one or more matching mechanisms. For example, one matching mechanism may use the output of one or more of the plurality of data conversion modules 320, 325 and may convert the output (e.g., Item) to a match item. This matching mechanism may be run against the output of one or more of the plurality of data conversion modules 320, 325 that produce program or series items containing identifications from multiple programming data stores 305, 310.

For example, programming data store 305 may have an associated identification “S1” and may include the movie “Blade Runner” with an associated identification “MvBR1,” resulting in a programming data store/programming data pair “S1-MvBR1”. Programming data store 310 may have an associated identification “S2” and also may include the movie “Blade Runner” with an associated identification “MBR101” resulting in a programming data store/programming data pair “S2-MBR101”. This matching mechanism may associate “S1-MvBR1” and “S2-MBR101” under the same match item identification.

Another matching mechanism may map online data sources, as programming data stores, formatted as XML data to a known standard format identification (e.g., TMS IDs). The matching mechanism may convert the converted (from XML data) programming data to match items. The main use for this matching mechanism is that the matching mechanism associates content from online sources (or from sitemaps) to standard (e.g., TMS) items. This matching mechanism may associate programming data from both programming data stores, as online data sources, under the same match item identification.

Still another matching mechanism may receive data from two programming data stores that both have schedule data. This matching mechanism may use an algorithm such as, if a program is on the same channel at the same time for the same lineup, then the program is the same program. The main use for this matching mechanism is to complement programming data from one programming data store with additional programming data from another programming data store. This matching mechanism may associate programming data from both programming data stores under the same match item identification.

The matching module 340 may include each type of matching mechanism. The matching mechanisms may run independently of each other. Each type of matching mechanism may have an associated data conversion module 320, 325, 330. Each matching mechanism may monitor a matching module 340 input, and if the input changes (e.g., when new data is downloaded to one of the data conversion modules 320, 325, 330) the matching mechanism may execute.

The unification module 345 may be configured to generate a unified view of the data from various providers. For example, the converted, matched, and unified programming data may be made available for discovery by a client as a unified data view using, for example, an application programming interface (API). The programming data made available for discovery by the client is unique in that a program (e.g., a movie or sporting event) is only discoverable once by the client regardless of the number of data stores 305, 310, 315 or providers that make the program available. In other words, the match item including like programming data may be presented to a client in an API as a unified view.

Further, the programming data may be collected over time. Therefore, an existing converted programming data may be the same as a new instance of the programming data (e.g., received from a new data source or newly added, changed or duplicated in an existing data source). The new instance (or plurality of instances) may be unified or merged with the existing converted programming data.

The unification module 345 may look at different locations of items and match items and create an output file set (e.g., unified view) so that a consumer (e.g., client device) of the items only needs to point to a single location. In addition, this will also assign global IDs to all entities. For example, this may set an Item.ProgramItem.program_id field to a value that is unique across all items in the output file set.

For each client a separate configuration file may exist, which may configure the unification module 345 to create a specific output unified data view. For example, the configuration file may indicate which programming data store 305, 310 to use as a source of selected programming. For example, the configuration file may indicate YouTube, Netflix or Amazon as the source of selected programming. The configuration file may be set by the consumer (e.g., client device). For example, the client may select preferred sources as part of a start-up, install or sign-up (e.g., initially contracting for a service). The configuration file may be set by the intermediate entity that is converted, matched, and unified programming data and providing the data to the consumer (e.g., client device). For example, the intermediate entity set the configuration file to select source of selected programming based of preferred contracts (e.g., best price) with providers (e.g., programming data store 305, 310).

The configuration file may also indicate that the source of selected programming may be dependent on the type of programming data. For example, a first type of programming may select a first source and a second type of programming may select a second source. For example, if the programming data is associated with music videos, YouTube may be the source of selected programming and if the programming data is associated with a movie, Netflix may be the source of selected programming.

The following is an example implementation of the unification module 345. The unification module 345 looks at all items and match items and if an item or match item has the same ID (e.g., programming data store/programming data pair) set as another item or match item then they are considered to be duplicates. The unification module 345 then assigns them a global ID using the following rules (in addition to updating all references to the item or match item). If the unification module 345 has not seen the item or match item before it gets a new generated global ID. If the unification module 345 has seen the item or match item before it gets the previously assigned ID. If the unification module 345 has seen some of the IDs in the ID set but not others, it gets the previously assigned ID. For example, for an item, if the unification module 345 has seen IDs from providers “a” and “b” and had previously assigned the item global ID “z” but now the item has an ID from provider “c”, the entity still gets global ID “z”.

If the unification module 345 has seen all of the IDs in the ID set but did not consider them to be the same item, the unification module 345 uses one of the previously assigned global IDs. For example, for an item, if the unification module 345 has seen IDs from providers “a” and “b” and had previously assigned the entity global ID “z” and the entity also has an ID from provider “c”, but previously assigned it global id “y”, the unification module 345 will now assign both entities above either ID “z” or “y”, for example, the oldest global ID. If the unification module 345 had previously determined that two entities were the same but are now different, they all get a new global ID. For example, for an item, if the unification module 345 has seen IDs from providers “a” and “b” and had previously assigned the entity global ID “z” but now the unification module 345 determines the entities are the same entity, “a” may be assigned global ID “y”, and entity “b” may be assigned global ID “x”.

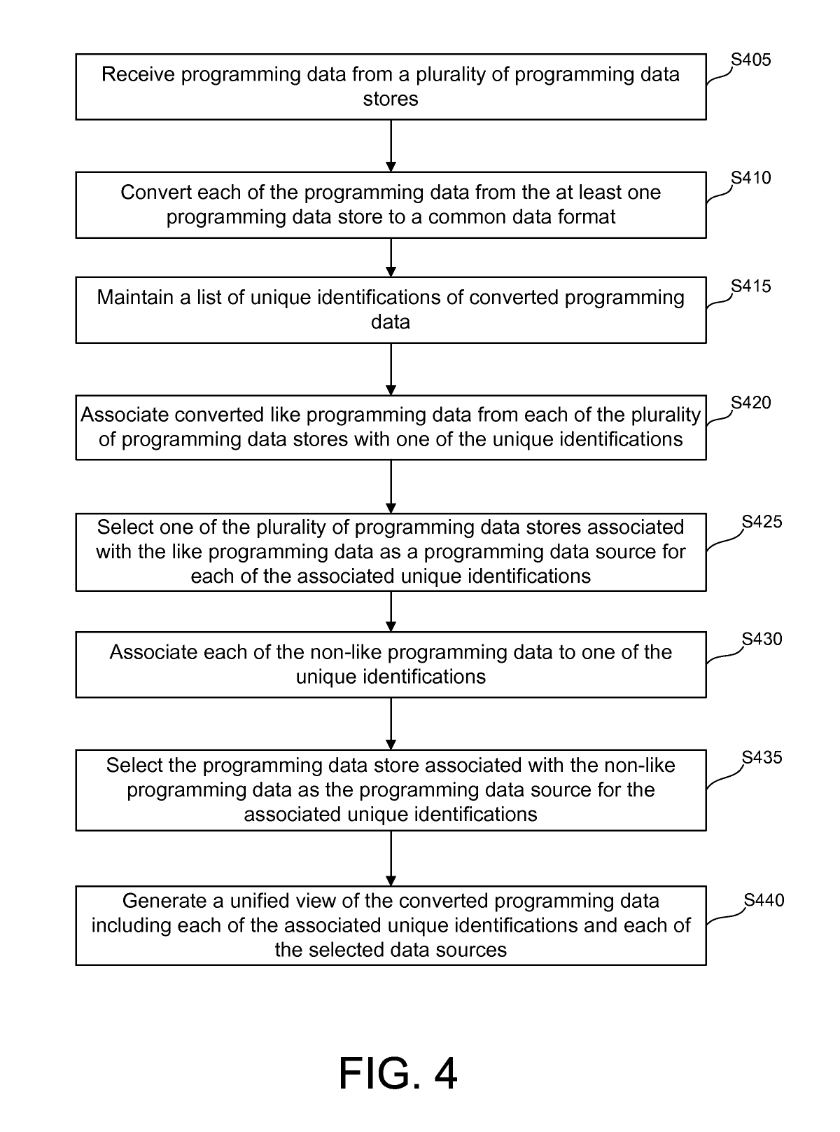

FIG. 4 is flowchart of a method for converting, matching and unifying data from multiple systems according to example embodiments. The method steps described with regard to FIG. 4 may be performed as a result of executing as software code stored in a memory by at least one processor. Although the steps described below are described as being executed by a processor, the steps are not necessarily executed by a same processor. In other words, more than one processor may execute the steps described below with regard to FIG. 4.

As shown in FIG. 4, in step S405 the data matching and unification module 302 receives programming data from a plurality of programming data stores. For example, as discussed above, the data matching and unification module 302 may be configured receive the programming data from the plurality of programming data stores 305, 310. The data matching and unification module 302 may be configured receive the programming data on an hourly, daily, weekly, upon start-up, before shutdown and/or the like time dependent fashion.

For example, as discussed above, a plurality of programming data stores 305, 310 may be configured to store programming data. Each of the plurality of programming data stores 305, 310 may store data in a different format. For example, the plurality of data sources (e.g., TMS, Netflix, Amazon, Dish VOD, and the like) may have associated programming data formatted in any one of a plurality of formats (e.g., XML, CSV, and the like).

The programming data may include associated information. The associated information may include, for example, program name, program source, schedule, actors, team names and the like. For example, the programming data may be associated with a sporting event. The associated information may include the type of sporting event (e.g., baseball), the teams that are playing, the date and time the game is to be played, a source name or provider identification (e.g., TMS), a source identification number or provider assigned identification (e.g., MLBRSY1234), and the like.

In step S410, the data matching and unification module 302 converts each of the programming data from the plurality of programming data stores to a common data format. For example, as discussed above, each of the plurality of programming data stores 305, 310 may store data in a different format. For example, the plurality of data sources (e.g., TMS, Netflix, Amazon, Dish VOD, and the like) may have associated programming data formatted in any one of a plurality of formats (e.g., XML, CSV, and the like).

As discussed above, the data matching and unification module 302 may be configured to convert programming data received from a programming data store into a common format or representation. For example, the common format may be a data structure called “Item”. The data structure called “Item” may have a plurality of defined variables. The plurality of defined variables may be related to a program, a series, a station (e.g., TV station), an event (e.g., sporting event), online programming, and the like. Therefore, the data structure called “Item” may have variable labeled as Item.Program, Item.Series, Item.TvStation, Item.TvEvent, Item.Online, and the like.

In step S415, the data matching and unification module 302 maintains a list of unique identifications of converted programming data. For example, the data matching and unification module 302 may store a sequential list of items and/or match items. The list of unique identifications may be a complete list, a partial list, a list of active items and/or match items and/or an indication of the next available identification number for assignment. The list of unique identifications may or may not be an element of the aforementioned data structure. The list of unique identifications may be stored in memory.

In step S420, the data matching and unification module 302 associates converted like programming data from each of the plurality of programming data stores with one of the unique identifications. As discussed above, programming data from one programming data store or provider with programming data from another programming data store or provider may be associated with a same match item. For example, the converted programming data may include like or duplicate data. As such, two providers may have a same program (e.g., movie or sporting event) available for viewing. Therefore, the like programming data may be matched as a match item.

For example, the data structure defining the common data may include an item identification (e.g., match item) for a plurality of like programming data from different data sources. Therefore, the data structure may store the item identification (e.g., as a unique number) in relation to the data source (e.g., as a provider identification and provider assigned identification pair for the programming data) for each of the data sources including the like programming data. Associating converted like programming data from each of the plurality of programming data stores with one of the unique identifications includes setting the item identification to the associated unique identification. Further, associating converted like programming data from each of the plurality of programming data stores with one of the unique identifications may include setting a match item identification to a same match item identification.

In step S425, the data matching and unification module 302 selects one of the plurality of programming data stores associated with the like programming data as a programming data source for each of the associated unique identifications. For example, as discussed above, each client may have a separate configuration file that may configure the data matching and unification module 302 to create a specific output unified data view. For example, the configuration file may indicate which programming data store 305, 310 to use as a source of selected programming. For example, the configuration file may indicate YouTube, Netflix or Amazon as the source of selected programming.

In step S430, the data matching and unification module 302 associates each of the non-like programming data to one of the unique identifications. For example, the data structure defining the common data may include an identification (e.g., item) for each of the remaining (e.g., non-matched) programming data. Therefore, the data structure may store the identification number in relation to the data source (e.g., as a provider identification and provider assigned identification pair for the programming data) for each of the remaining data sources including the non-like programming data.

In step S435, the data matching and unification module 302 selects the programming data store associated with the non-like programming data as the programming data source for the associated unique identifications. For example, as discussed above, each client may have a separate configuration file that may configure the data matching and unification module 302 to create a specific output unified data view. For example, the configuration file may indicate which programming data store 305, 310 to use as a source of selected programming. The programming data store 305, 310 may be the programming data store associated with the non-like programming data.

In step S440, the data matching and unification module 302 generates a unified view of the converted programming data including each of the associated unique identifications and each of the selected data sources. For example, as discussed above, the data matching and unification module 302 may look at different locations of items and match items and create an output file set (e.g., unified view) so that a consumer of the items only needs to point to a single location. In addition, this will also assign global IDs to all entities. For example, this may set an Item.ProgramItem.program_id field to a value that is unique across all items in the output file set.

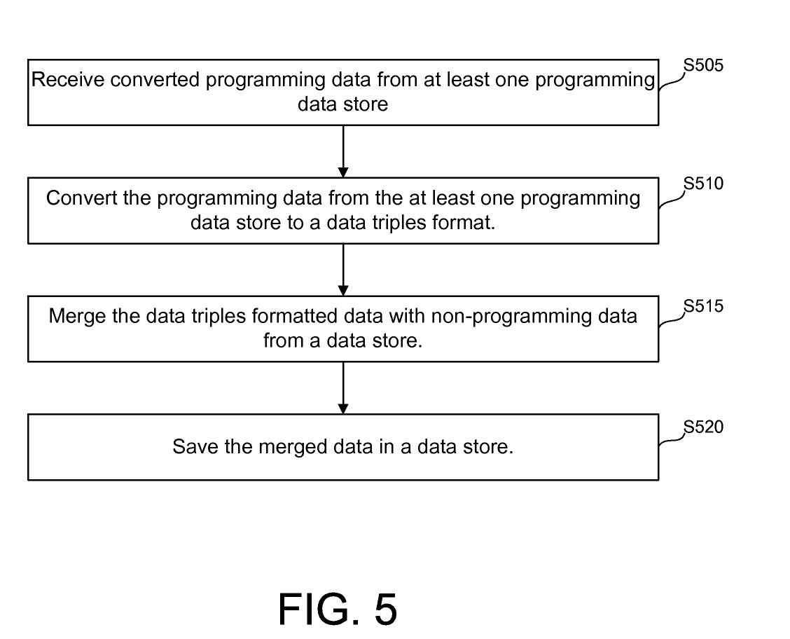

FIG. 5 is a flowchart of an example method for merging data from multiple systems according to example embodiments. The method steps described with regard to FIG. 5 may be executed as software code stored in a memory associated with a system (e.g., as shown in FIG. 3) and executed by at least one processor associated with the system. Although the steps described below are described as being executed by a processor, the steps are not necessarily executed by a same processor. In other words, more than one processor may execute the steps described below with regard to FIG. 5.

As shown in FIG. 5, in step S505 the data matching and unification module 302 receives converted programming data from at least one programming data store. For example, the data matching and unification module 302 (e.g., the non-programming data selection module 335) may be configured to select programming data from one or more converted programming data sources (e.g., the plurality of data conversion modules 320, 325). The data matching and unification module 302 may be configured to select programming data that is relevant to the non-programming data store 315 (e.g., actors in a movie or rating of a movie).

In step S510, the data matching and unification module 302 converts the programming data from the at least one programming data store to a data triples format. For example, the data matching and unification module 302 may format the converted programming data as a triple which represents two entities and the relationship between them, for example in a <subject; predicate; object>format. According to example embodiments, the non-programming data store 315 may be a graph-based data store configured to stores triples, also referred to as tuples that represent entities and relationships. A triple may include a <subject; predicate; object>format, with the subject representing a starting entity, the predicate representing an outward edge from the subject, and the object representing the entity pointed to by the outward edge. One or more of the triple elements may include a place holder. For example, the converted programming data may only include data which represents two entities. However, the relationship between the two entities may be indeterminable and/or incomplete.

In step S515, the data matching and unification module 302 may communicate and/or transmit the formatted data triple data to the non-programming data store 315 and the non-programming data store 315 merges the data triples formatted data with non-programming data from a data store. For example, if the formatted data triple data is complete (e.g., includes all three elements), the non-programming data store 315 may merge by checking for duplicates and adding the data triples formatted data if there are no duplicates. For example, if the formatted data triple data is incomplete (e.g., does not include all three elements and/or one element is a place holder), the non-programming data store 315 may merge by completing the data triple (e.g., building relationships, checking for duplicates and adding the data triples formatted data if there are no duplicates.

In step S520, the non-programming data store 315 saves the merged data in a data store. For example, the non-programming data store 315 may store the merged, formatted data triples in an associated memory (not-shown).

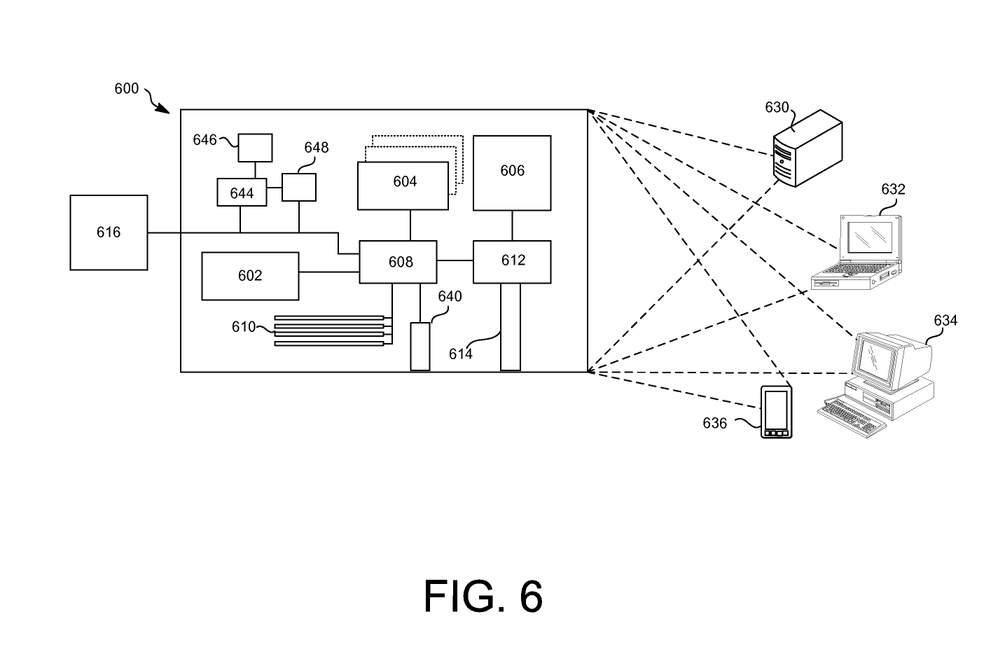

FIG. 6 shows an example of a computer device 600, which may function as one of the devices operating as a data store (e.g., programming data stores 305, 310 or non-programming data store 315) of FIG. 3, which may be used with the techniques described here. Computing device 500 is intended to represent various example forms of computing devices, such as laptops, desktops, workstations, personal digital assistants, televisions, settop boxes, cellular telephones, smart phones, tablets, servers, and other computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, and expansion ports 610 connected via an interface 608. In some implementations, computing device 600 may include transceiver 646, communication interface 644, and a GPS (Global Positioning System) receiver module 648, among other components, connected via interface 608. Device 600 may communicate wirelessly through communication interface 644, which may include digital signal processing circuitry where necessary. Each of the components 602, 604, 606, 608, 610, 640, 644, 646, and 648 may be mounted on a common motherboard or in other manners as appropriate.

The processor 602 can process instructions for execution within the computing device 600, including instructions stored in the memory 604 or on the storage device 606 to display graphical information for a GUI on an external input/output device, such as display 616. Display 616 may be a monitor or a flat touchscreen display. In some implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk. In some implementations, the memory 604 may include expansion memory provided through an expansion interface.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in such a computer-readable medium. The computer program product may also contain instructions that, when executed, perform one or more methods, such as those described above. The computer- or machine-readable medium is a storage device such as the memory 604, the storage device 606, or memory on processor 602.

The interface 608 may be a high speed controller that manages bandwidth-intensive operations for the computing device 600 or a low speed controller that manages lower bandwidth-intensive operations, or a combination of such controllers. An external interface 640 may be provided so as to enable near area communication of device 600 with other devices. In some implementations, interface 608 may be coupled to storage device 606 and expansion port 614. The expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 630, or multiple times in a group of such servers. It may also be implemented as part of a rack server system. In addition, it may be implemented in a personal computer such as a laptop computer 622, or smart phone 636. An entire system may be made up of multiple computing devices 600 communicating with each other. Other configurations are possible.

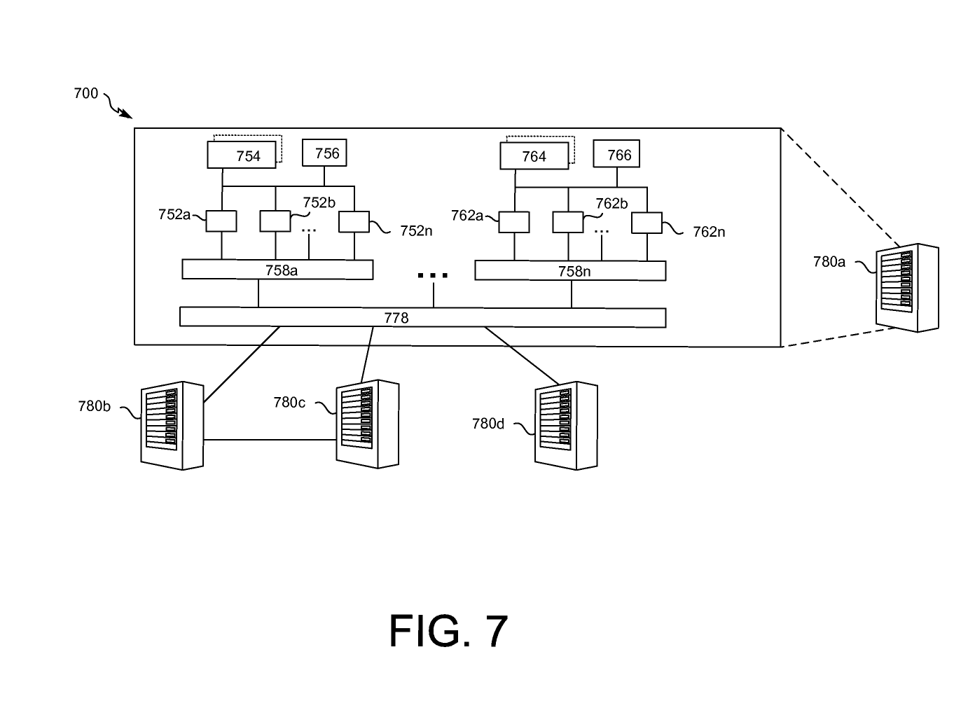

FIG. 7 shows an example of a generic computer device 700, which may function as one of the devices operating as a data store (e.g., programming data stores 305, 310 or non-programming data store 315) of FIG. 3, which may be used with the techniques described here. Computing device 700 is intended to represent various example forms of large-scale data processing devices, such as servers, blade servers, datacenters, mainframes, and other large-scale computing devices. Computing device 700 may be a distributed system having multiple processors, possibly including network attached storage nodes, that are interconnected by one or more communication networks. The components shown here, their connections and relationships, and their functions, are meant to be exemplary only, and are not meant to limit implementations of the inventions described and/or claimed in this document.

Distributed computing system 700 may include any number of computing devices 780. Computing devices 780 may include a server or rack servers, mainframes, etc. communicating over a local or wide-area network, dedicated optical links, modems, bridges, routers, switches, wired or wireless networks, etc.

In some implementations, each computing device may include multiple racks. For example, computing device 780a includes multiple racks 758a-758n. Each rack may include one or more processors, such as processors 752a-752n and 762a-762n. The processors may include data processors, network attached storage devices, and other computer controlled devices. In some implementations, one processor may operate as a master processor and control the scheduling and data distribution tasks. Processors may be interconnected through one or more rack switches 758, and one or more racks may be connected through switch 778. Switch 778 may handle communications between multiple connected computing devices 700.

Each rack may include memory, such as memory 754 and memory 764, and storage, such as 756 and 766. Storage 756 and 766 may provide mass storage and may include volatile or non-volatile storage, such as network-attacked disks, floppy disks, hard disks, optical disks, tapes, flash memory or other similar solid state memory devices, or an array of devices, including devices in a storage area network or other configurations. Storage 756 or 766 may be shared between multiple processors, multiple racks, or multiple computing devices and may include a computer-readable medium storing instructions executable by one or more of the processors. Memory 754 and 764 may include, e.g., volatile memory unit or units, a non-volatile memory unit or units, and/or other forms of computer-readable media, such as a magnetic or optical disks, flash memory, cache, Random Access Memory (RAM), Read Only Memory (ROM), and combinations thereof. Memory, such as memory 754 may also be shared between processors 752a-752n. Data structures, such as an index, may be stored, for example, across storage 756 and memory 754. Computing device 700 may include other components not shown, such as controllers, buses, input/output devices, communications modules, etc.

An entire system, such as system 300, may be made up of multiple computing devices 700 communicating with each other. For example, device 780a may communicate with devices 780b, 780c, and 780d, and these may collectively be known as system 300. As another example, system 300 of FIG. 3 may include one or more computing devices 700, a separate computing device 700, and one or more computing devices 700 as serving cluster. Furthermore, some of the computing devices may be located geographically close to each other, and others may be located geographically distant. The layout of system 700 is an example only and the system may take on other layouts or configurations.

Various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any non-transitory computer program product, apparatus and/or device (e.g., magnetic discs, optical disks, memory (including Read Access Memory), Programmable Logic Devices (PLDs)) used to provide machine instructions and/or data to a programmable processor.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

Some of the above example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example embodiments. Example embodiments, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example embodiments and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative embodiments, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example embodiments are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or embodiments herein disclosed irrespective of whether or not that particular combination has been specifically enumerated in the accompanying claims at this time.

What is claimed is:

1. A method, comprising:
receiving programming data from a plurality of programming data stores, the programming data being in one of a plurality of formats, each of the received programming data having a data store identification;
converting each of the programming data to a common data format, the common data format being different than each of the plurality of data formats of the received data;
maintaining a list of unique identifications of converted programming data;
associating converted like programming data received from the plurality of programming data stores with one of the unique identifications, wherein like programming data received from different programming data stores is associated with the same program content;
selecting one of the plurality of programming data stores associated with the like programming data as a programming data source for each of the associated unique identifications; and
generating a unified view of the converted programming data including each of the associated unique identifications and each of the selected data sources.

2. The method of claim 1, further comprising:
receiving non-programming data from a non-programming data store, the programming data being in a data format different than the common data format;
converting the non-programming data to the common data format; and
if the non-programming data is associated with one of the converted programming data, associating the non-programming data with the respective same identification, wherein generating the unified view includes the converted non-programming data.

3. The method of claim 1, further comprising:
generating data triples based on the converted programming data; and
transmitting the data triples to a non-programming data store.

4. The method of claim 1, wherein
the common data format is a data structure including a plurality of variables, and
converting each of the programming data to the common data format includes mapping programming data to one or more of the plurality of variables.

5. The method of claim 4, wherein mapping programming data to one or more of the plurality of variables is based on a helper class, the helper class including programming data store specific code including a lexicon for the programming data store referenced to the plurality of variables.

6. The method of claim 1, wherein
the common data format is a data structure including a plurality of variables,
one of the plurality of variables is an item identification, and
associating converted like programming data from each of the plurality of programming data stores with one of the unique identifications includes setting the item identification to the associated unique identification.

7. The method of claim 6, wherein
the list of unique identifications includes a plurality of unique match item identifications,
one of the plurality of variables is a match item identification, and
associating converted like programming data from each of the plurality of programming data stores with one of the unique identifications includes setting the match item identification to a same match item identification.

8. The method of claim 1, further comprising:
associating converted non-like programming data with one of the unique identifications;
selecting the programming data store associated with the non-like programming data as the programming data source for the associated unique identifications; and

9. The method of claim 8, wherein
the common data format is a data structure including a plurality of variables,
one of the plurality of variables is an item identification, and
associating each of the non-like programming data to one of the unique identifications includes setting the item identification to the associated unique identification.

10. The method of claim 1, wherein selecting one of the plurality of programming data stores associated with the like programming data as a programming data source for each of the associated unique identifications includes associating a an identification of the programming data source with a client device in a configuration file.

11. The method of claim 1, wherein selecting the programming data store associated with the non-like programming data as the programming data source for the associated unique identifications includes associating a an identification of the programming data source with a client device in a configuration file.

12. The method of claim 1, wherein generating a unified view of the converted programming data including each of the associated unique identifications and each of the selected data sources includes making the converted programming data available for discovery by a client device using an application programming interface such that a program associated with the converted programming data is only discoverable once by the client.

13. An apparatus, comprising:
at least one processor, and
at least one memory storing code segments that when executed by the processor cause the processor to,
receive programming data from a plurality of programming data stores, the programming data being in one of a plurality of formats, each of the received programming data having a data store identification;
convert each of the programming data to a common data format, the common data format being different than each of the plurality of data formats of the received data;
maintain a list of unique identifications of converted programming data;
associate converted like programming data received from the plurality of programming data stores with one of the unique identifications, wherein like programming data received from different programming data stores is associated with the same program content;
select one of the plurality of programming data stores associated with the like programming data as a programming data source for each of the associated unique identifications; and
generate a unified view of the converted programming data including each of the associated unique identifications and each of the selected data sources.

14. The apparatus of claim 13, wherein the memory storing code segments that when executed by the processor further cause the processor to,
associate converted non-like programming data with one of the unique identifications;
select the programming data store associated with the non-like programming data as the programming data source for the associated unique identifications; and

15. The apparatus of claim 14, wherein
the common data format is a data structure including a plurality of variables,
one of the plurality of variables is an item identification, and
associating each of the non-like programming data to one of the unique identifications includes setting the item identification to the associated unique identification.

16. The apparatus of claim 13, wherein the memory storing code segments that when executed by the processor further cause the processor to,
receive non-programming data from a non-programming data store, the programming data being in a data format different than the common data format;
convert the non-programming data to the common data format; and
if the non-programming data is associated with one of the converted programming data, associating the non-programming data with the respective same identification, wherein generating the unified view includes the converted non-programming data.

17. The apparatus of claim 13, wherein the memory storing code segments that when executed by the processor further cause the processor to,
generate data triples based on the converted programming data; and
transmit the data triples to a non-programming data store.

18. The apparatus of claim 13, wherein
the common data format is a data structure including a plurality of variables, and
converting each of the programming data to the common data format includes mapping programming data to one or more of the plurality of variables.

19. The apparatus of claim 18, wherein mapping programming data to one or more of the plurality of variables is based on a helper class, the helper class including programming data store specific code including a lexicon for the programming data store referenced to the plurality of variables.

20. The apparatus of claim 13, wherein generating a unified view of the converted programming data including each of the associated unique identifications and each of the selected data sources includes making the converted programming data available for discovery by a client device using an application programming interface such that a program associated with the converted programming data is only discoverable once by the client.
